(19) United States
(12) Patent Application Publication
(10) Pub. No.: US 2002/0083438 A1
(43) Pub. Date: Jun. 27, 2002

(54) System for securely delivering encrypted content on demand with access contrl

(76) Inventors: Nicol Chung Pang So, Bensalem, PA (US); John I. Okimoto, San Diego, CA (US); Annie On-Yee Chen, Del Mar, CA (US); Lawrence W. Tang, San Diego, CA (US); Akiko Wakabayashi, San Diego, CA (US); Keith R. Cochran, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/898,184

(22) Filed: Jul. 3, 2001

Related U.S. Application Data
(60) Provisional application No. 60/263,087, filed on Jan. 18, 2001.
(60) Provisional application No. 60/243,925, filed on Oct. 26, 2000.

(51) Int. Cl. H04N 7/167; H04N 7/00; H04N 11/00

(52) U.S. Cl. 725/31; 348/460; 380/210; 380/277

(57) ABSTRACT

A method of delivering content from a head end to subscriber terminals within one or more cable systems. Such content may be video, audio or the like. The method includes the step of encrypting the content offline to form pre-encrypted content, generating an encryption record containing parameters employed for encrypting the content. Based on the encryption record, a control message for permitting access to the pre-encrypted content is generated using a periodical key provided by the first cable system. The pre-encrypted content and associated control message is thereafter forwarded to the first subscriber terminal for decryption of the content. For a second subscriber terminal within a second cable system, the pre-encrypted content is retrofitted with a second control message permitting the pre-encrypted content to be decrypted by the second subscriber terminal. Further, multiple versions of a control message for multiple service tiers within a cable system may be generated, each version for permitting access to a particular service tier within the system.

### BACKGROUND OF THE INVENTION

The present invention relates generally to the field of content communication and more specifically to a system for communicating video content on-demand through a communication network.

Conventional systems for delivering video content on-demand to subscribers are becoming well known. VOD (video on-demand) is an interactive service in which content (e.g., video) is delivered to a subscriber over a network (e.g., a cable system) on an on-demand basis. A subscriber may order and receive programming content at any time, without adhering to a predefined showing schedule. The subscriber is often provided VCR-like motion control functions, such as pause (freeze frame), slow motion, scan forward, and slow backward. The subscriber is typically allowed multiple viewings of a purchased program within a time window, e.g., 24 hours. VOD mimics (or exceeds) the level of control and convenience of rental video tapes. For a VOD service to prevent unauthorized access, the system implementing it provides some form of conditional access.

Conditional Access

The system implementing VOD provides the capability to limit content access to authorized subscribers only, as the contents delivered as part of the service are generally considered valuable intellectual properties by their owners. In cable and satellite television, such capability is known as conditional access. Conditional access requires a trustworthy mechanism for classifying subscribers into different classes, and an enforcement mechanism for denying access to unauthorized subscribers. Encryption is typically the mechanism used to deny unauthorized access to content (as opposed to carrier signal).

Tiering of Services

To distinguish between authorized and unauthorized subscribers, and between different levels of authorization, a concept of class of services is employed. A “tier,” in conventional cable or satellite TV terminology, is a class of services. It can also be viewed as a unit of authorization, or an access privilege that can be granted, revoked, or otherwise managed.

Key Management

In a system that employs encryption, key management refers to all aspects of the handling of cryptographic keys, including their generation, distribution, renewal, expiration, and destruction. The goal of key management to make sure that all parties can obtain exactly the cryptographic keys to which they are authorized under an access control policy. Access control is effected by careful control over the distribution of keys. In a conditional access system for cable systems, conditional access is implemented with the use of two classes of control messages: entitlement control messages (ECMs) and entitlement management messages (EMMs).

Entitlement Management Messages

EMMs are control messages that convey access privileges to subscriber terminals. Unlike ECMs (entitlement control messages) which are embedded in transport multiplexes and are broadcast to multiple subscribers, EMMs are sent unicast-addressed to each subscriber terminal. That is, an EMM is specific to a particular subscriber. In a typical implementation, an EMM contains information about the periodical key, as well as information that allows a subscriber terminal to access an ECM which is later sent. A periodical key is typically periodical, controlling access to content by receiving units (set-top boxes, etc). Upon expiration of the periodical key, no set-top can decrypt content until the periodical key is renewed. EMMs also define the tiers for each subscriber. With reference to cable services, for example, a first EMM may allow access to HBO™, ESPN™ and CNN™. A second EMM may allow access to ESPN™, TNN™ and BET™, etc.

Entitlement Control Messages

In a conditional access system, each content stream is associated with a stream of ECM that serves two basic functions: (1) to specify the access requirements for the associated content stream (i.e., what privileges are required for access for particular programs); and (2) to convey the information needed by subscriber terminals to compute the cryptographic key(s), which are needed for content decryption. ECMs are transmitted in-band alongside their associated content streams. Typically, ECMs are cryptographically protected by a “periodical key” which changes periodically, usually on a category basis. The periodical key is typically distributed by EMMs prior to the ECMs, as noted above.

Encryption

In a network, such as a cable system, for example, carrier signals are broadcast to a population of subscriber terminals (also known as set-top boxes). To prevent unauthorized access to service, encryption is often employed. When content is encrypted, it becomes unintelligible to persons or devices that don't possess the proper cryptographic key(s). A fundamental function of a conditional access system is to control the distribution of keys to the population of subscriber terminals, to ensure that each terminal can compute only the keys for the services for which it is authorized. Traditionally, in broadcast services, an encryption device is placed on the signal path before the signal is placed on the distribution network. Thereafter, the encryption device encrypts the signal and its content in real time. This technique is acceptable because a large number of subscribers share the same (relatively small number of) content streams.

Disadvantageously, for VOD, real-time encryption poses much greater cost and space issues. A medium-sized network such as a cable system may have, for example, 50, 000 subscribers. Using a common estimate of 10% peak simultaneous usage, there can be up to 5000 simultaneous VOD sessions during the peak hours. A typical encryption device can process a small number of transport multiplexes (digital carriers). A relatively high number of such real-time encryption devices would be needed to handle the peak usage in the example system. Such a large amount of equipment not only adds significantly to the system cost, but also poses a space requirement challenge.

Therefore, there is a need to resolve the aforementioned problem relating to the conventional approach for securely delivering pre-encrypted content, and the present invention meets this need.

### SUMMARY OF THE INVENTION

Various aspects of the present invention are present in a system for securely delivering encrypted content on-demand with access control. Unlike related art systems that employ real time encryption, the embodiments of the present system encrypt content offline (typically before the content is requested by the user) before it is distributed to point-to-point, point-to-multipoint systems, or multicast systems e.g., a cable system. The system allows content to be encrypted once, at a centralized facility, and to be useable at different point-to-point systems. Advantageously, the pre-encrypted contents in the present invention have indefinite lifetimes. The system periodically performs an operation called ECM retrofitting enabling the content to be useable in multiple systems and useable multiple times in the same system. The amount of data being processed during ECM retrofitting is very small (on the order of several thousand bytes). There is no need to reprocess the pre-encrypted contents. This is a significant advantage, as several thousand bytes represent only a tiny fraction of the size of a typical 2-hour video program, which may be about 3 gigabytes (3,000,000,000 bytes) in size.

According to a first aspect of the present invention, a system for delivering content to a subscriber terminal on-demand through a communication network is disclosed. The system includes a content preparation module for pre-encrypting the content offline to form pre-encrypted content; an on-demand module receiving the pre-encrypted content from the content preparation module, and for forwarding the pre-encrypted content to the subscriber terminal when authorized; an encryption renewal system interfacing with the on-demand module to generate entitlement control messages allowing the pre-encrypted content to be decryptable for a designated duration; and a conditional access system for providing a periodical key to the encryption renewal system, to permit generation of the entitlement control messages, which convey to the subscriber terminal, information required to compute the periodical key in order to enable decryption of the pre-encrypted content.

According to another aspect of the present invention, a method of delivering content from a head end to subscriber terminals within one or more cable systems is disclosed. The method involves the steps of receiving a request for the content from a first subscriber terminal of a first cable system; pre-encrypting the content to form pre-encrypted content prior to the step of receiving a request; generating an encryption record containing parameters employed for encrypting the content; generating one or more control messages for permitting access to the pre-encrypted content based on the encryption record and a first key information; and forwarding the pre-encrypted content associated with the one or more control messages to the first subscriber terminal for decryption of the pre-encrypted content.

According to another aspect of the present invention, the method further includes receiving a request from a second subscriber terminal of a second cable system, and based on the encryption record and a second key information, generating one or more control messages for permitting the second subscriber terminal to access the pre-encrypted content.

According to another aspect of the present invention, the key information is provided by a conditional access system that uses the key information to control the first subscriber terminal. In a further aspect, the key is periodical and is valid for a designated duration. Further yet, the designated duration is shortly before, contemporaneous with, or shortly after the first key is changed by the conditional access system.

According to another aspect of the present invention, the one or more control messages is a first entitlement control message for conveying information to the first subscriber terminal to compute the key.

According to another aspect of the present invention, the method comprises the step of retrofitting a second entitlement control message to the pre-encrypted content for permitting access to the pre-encrypted content after the first key information expires.

According to another aspect of the present invention, the step of retrofitting the second entitlement control message is synchronized with changing of the first key to the second key.

According to another aspect of the present invention, the method includes providing the parameters from an encryption renewal system that generates the one or more entitlement control messages, and the step of generating an encryption record is by an offline encryption system, and providing first and second service tiers in the first cable system to further limit access to the pre-encrypted content.

According to another aspect of the present invention, the method contains the steps of generating a first entitlement control message allowing the first subscriber terminal to access the pre-encrypted content only in the first service tier, and generating a second entitlement message allowing a second subscriber terminal to access the pre-encrypted content only in the second service tier.

According to another aspect of the present invention, a system for delivering first and second content to a subscriber terminal on-demand through a communication network is disclosed. The system includes a means for pre-encrypting the first and second content offline to form first and second pre-encrypted content, and for generating a first encryption record associated with the first pre-encrypted content, and a second encryption record for the second pre-encrypted content; means for generating first and second entitlement messages that allow decryption of the first and second pre-encrypted contents, respectively; a conditional access system for providing information included in the first and second entitlement messages by the means for generating; and means for receiving the pre-encrypted content from the means for preencrypting, forwarding the first and second encryption records to the means for generating which generates the first and second entitlement messages for forwarding to the subscriber terminal.

According to another aspect of the present invention, a means for generating a third entitlement message, wherein the third entitlement message is for permitting access to the first pre-encrypted content after expiration of the first entitlement message is disclosed.

According to another aspect of the present invention, a method permitting first and second cable systems to control subscriber access to pre-encrypted content previously encrypted offline is disclosed. The method includes the steps of receiving a first cryptographic information from the first cable system; receiving an encryption record containing parameters employed during encryption to form the pre-encrypted content; and generating for the first cable system, a first control message for providing access to the pre-encrypted content based on the first cryptographic information and the first encryption record.

According to another aspect of the present invention, the present invention is a system for delivering content to a subscriber terminal on-demand through a point-to-point communication network, the system including: an offline encryption system having software containing one or more instructions for pre-encrypting the content to form pre-encrypted content before a content request is received from the subscriber terminal; a video on-demand system including software having one or more instructions for receiving the pre-encrypted content from the offline encryption system, and forwarding the pre-encrypted content to the subscriber terminal; and an encryption renewal system interfacing with the offline encryption system to provide encryption parameters for encrypting the content, and interfacing with the video on-demand system to generate entitlement control messages allowing the pre-encrypted content to be decryptable for a designated duration, wherein the encryption control messages are generated by using a periodical key.

According to another aspect of the present invention, the encryption renewal system generates first and second versions of an entitlement control message for accessing the pre-encrypted content in a first and a second tier, respectively.

According to another aspect of the present invention, the encryption renewal system provides a call back mechanism indicating the time by which the video on-demand system should contact the encryption renewal system.

According to another aspect of the present invention, the method includes maintaining a list of first, second and third cable systems and their addressing information.

Advantageously, the present invention incorporates all of the advantages of point-to-point services (i.e., video on-demand) such as the inability of unauthorized persons to access content since there are no predefined schedules and VOD service is interactive and delivered to only a single subscriber. As noted, the embodiments of the present invention allow content to be encrypted once, at a centralized facility, and to be useable at different point-to-point systems, and the pre-encrypted content has an indefinite lifetime. Further, multiple content may be pre-encrypted for handling and distribution by components of the present invention. Moreover, further security measures are provided by including tiers for subscriber terminals.

### BRIEF DESCRIPTION OF THE DRAWINGS

FIG. 1 is a system architecture for delivering pre-encrypted content to a subscriber in accordance with a first embodiment of the present invention.

FIG. 2 is an exemplary flow diagram of the steps for ECM retrofitting in accordance with a first embodiment of the present invention.

FIG. 3 is block diagram of the content preparation system of FIG. 1 for encrypting content offline in accordance with an exemplary embodiment of the present invention.

FIG. 4 is an exemplary embodiment of the encryption renewal system of FIG. 1.

FIG. 5 is a block diagram of a network for securely communicating pre-encrypted content in accordance with an exemplary embodiment of FIG. 1.

FIG. 6 is a sequence diagram of the video encryption renewal broker of FIG. 4 showing a VOD system transaction servlet initialization sequence of the objects involved in processing the VOD system transactions.

A further understanding of the nature and advantages of the present invention herein may be realized by reference to the remaining portions of the specification and the attached drawings. Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, the same reference numbers indicate identical or functionally similar elements.

### DETAILED DESCRIPTION OF THE INVENTION

A first embodiment of the present invention discloses a system for securely delivering encrypted content on-demand with access control. The system pre-encrypts the content prior to being distributed through a point-to-point communication system (e.g., cable systems, for example). Content is encrypted once at a centralized facility and is useable at different point-to-point systems. Although described with reference to point-to-point systems, the present invention is applicable to point-to-multipoint systems. Advantageously, the pre-encrypted contents in the present invention have indefinite lifetimes. The system periodically performs an operation called ECM (entitlement control message) retrofitting to keep pre-encrypted contents useable.

Briefly, the system includes a content preparation module for preencrypting the content offline to form pre-encrypted content. The pre-encrypted content is forwarded to a video on-demand module that stores the content for forwarding to the subscriber terminal when authorized. An encryption renewal system interfaces with the video on-demand module to carry out ECM retrofitting. The ECM retrofitting process generates entitlement control message using a key that allows the pre-encrypted content to be decryptable for a designated duration. The key (typically periodical) is generated by a conditional access system and forwarded to the encryption renewal system for the ECM retrofitting process. Following retrofitting, the entitlement control message conveys to the subscriber terminal information required to compute the key in order to decrypt the pre-encrypted content.

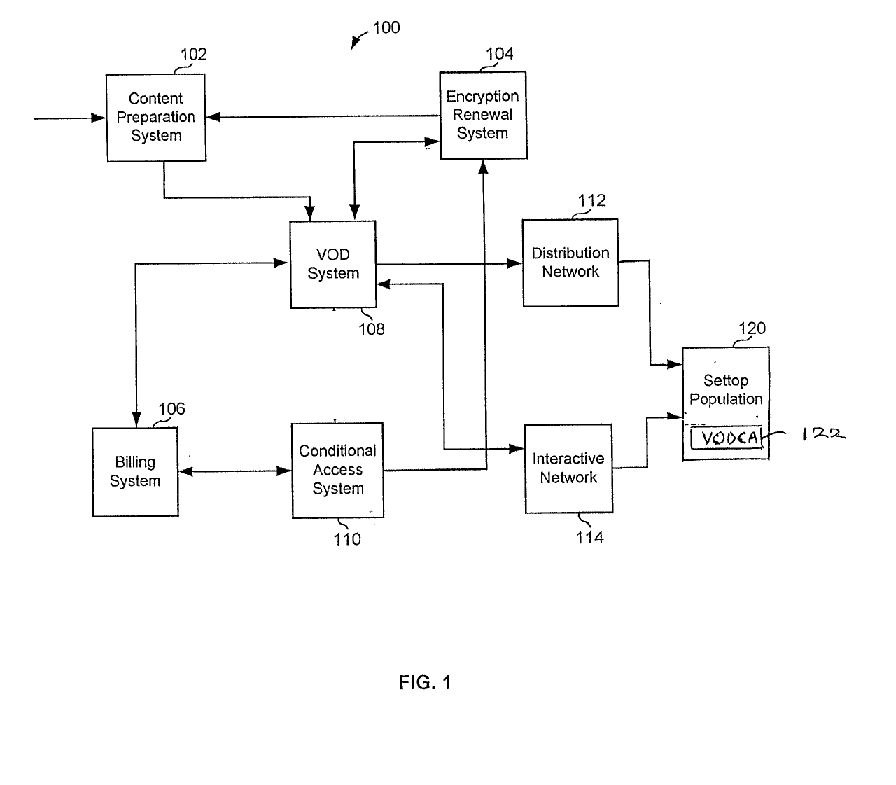

FIG. 1 is a system architecture 100 for delivering encrypted content to a subscriber in accordance with a first embodiment of the present invention.

Among other components, system architecture 100 comprises a content preparation system (CPS) 102 for pre-encrypting content, a video on-demand (VOD) system 108 storing encrypted programs for distribution to subscribers on an on-demand basis, a conditional access system 110 for controlling one or more keys granting access to pre-encrypted content, an encryption renewal system ERS 104 accepting requests from the video on-demand system to generate new entitlement control messages for pre-encrypted content, a distribution network 112 for distributing content, and an interactive network 114 providing two-way interaction between the subscriber and the content system. Although not shown, one of ordinary skill in the art would realize that other components and arrangements for achieving the various functionalities of system architecture 100 are possible. For example, a VOD system may be coupled directly to CAS 110 and functionalities consolidated in both components since both components are typically located within a cable system head end.

In operation, the VOD system 108 is installed to provide VOD to subscribers. Before going live, VOD system 108 goes through a registration process with the ERS 104. This establishes the identity of the VOD system 108 to the ERS so it can produce proper and appropriate responses specific to that VOD system installation. Once the VOD system registration is complete, content may be added to the VOD system and made available to subscribers. Clear content (a), such as a movie, originates from a content provider and begins its entry to the VOD at CPS 102. Here, the clear content is encrypted using an Off Line Encryption System (OLES) (not shown), which pre-encrypts the content in preparation for delivery by VOD system 108. The OLES also generates an encryption record associated with the encrypted content. Note that the VOD system may keep the encryption record with the pre-encrypted content at all times as it identifies the content for later processing and decryption within VOD system 108.

Once the clear content is encrypted at the OLES, the resulting pre-encrypted content and associated encryption record are delivered to VOD system 108 for storage on the local server. Advantageously, multiple VOD systems may be coupled to CPS 102 such that content is encrypted once and distributed to the systems. VOD system 108 is responsible for keeping the pre-encrypted content and associated encryption record together. Before the pre-encrypted content may be requested or viewed by subscribers in their homes, VOD system 108 obtains suitable Entitlement Control Messages (ECMs) from the ERS 104. The VOD system submits an ECM request to ERS 104, containing the encryption record for the desired pre-encrypted content.

ERS 104 responds with the proper ECMs, an ERS synchronization number, and a callback time. The ECMs are created specifically for the particular pre-encrypted content and particular point-to-point system within which the VOD system operates, and for a particular time period. The ECMs are cryptographically protected using a key (typically periodical) provided by each conditional access system (CAS 110 in the present case) controlling the set-top boxes. VOD system (108) inserts the received ECMs into the streams along with the pre-encrypted content whenever it is spooled out to a subscriber. The ECMs are inserted into the streams with the content.

It should be observed that ECMs returned to VOD system 108 by ERS 104 are valid and useable with the pre-encrypted content only for a limited time-the exact time is determined by the CAS 110 and is not predictable in advance. Thus, the callback time returned with the ECMs indicates the time by which VOD system 108 should check with the ERS to see if ECMs for all pre-encrypted content may be updated. When the VOD system receives the callback time, it should be stored and tracked against the current time. If the callback time is reached and the VOD system 108 has not contacted ERS 104 in the intervening time, then VOD system 108 attempts to contact the ERS 104 even if it has no new ECM requests to fulfill.

Content Preparation System (CPS)

In FIG. 1, content preparation system (CPS) 102 is a centralized facility for preparing contents according to the requirements of the VOD system (VOD) 108 and those of the Conditional Access system (CAS) 110. CPS 102 encodes content in a format (e.g., MPEG-2) suitable for storage on video servers and for distribution to the subscriber terminals. For content that is already available in the suitable format, this encoding step may be unnecessary. CPS 102 also functions to encrypt digitally encoded content according to the specifications of CAS 110.

The encryption process involves generating one or a series of cryptographic keys. As part of the encryption process, the cryptographic keys, or the parameters used in their generation, are saved in a data structure called an encryption record. The encryption record is protected by encryption to prevent unauthorized access to the keys. CPS 102 may package encrypted programs with the associated encryption records, which may additionally contain useful but nonessential information about the content. Such information may include program title, identification of the program assigned by different parties, encoding parameters, program length, etc. CPS 102 may serve multiple cable systems or multiple point-to-point systems. The content preparation process described above produces encoded and encrypted content ready for distribution to VODS across a diverse geographic area. Some potential methods of content file distribution are via physical media, network file transfer, or satellite file transfer.

Although not shown, CPS 102 includes an OLES (offline encryption) device for performing the aforementioned functionality. The OLES uses one or more non-real-time, or offline, encryption devices to encrypt content. A given OLES generates program-specific cryptographic keys that are used to encrypt content. The OLES is protected by physical security including physical access control and secure packaging. The OLES functions such as accepting encryption control provisioning parameters from the ERS including cryptographic information to support content encryption; selecting one or more cryptographic keys based on the encryption control parameters and system configuration, which keys are used for encrypting the program content; generating an encryption record, which contains information about the keys used to encrypt the content. The record itself is encrypted to maintain the security of the encryption record; encrypting the program content using the chosen keys; and providing the encrypted content and the encryption record to the CPS, for subsequent transfer to at least one VODS.

Typically, an OLES is registered and authorized by the ERS 104 prior to performing encryption operations. ERS 104 provides a removable media disk containing authorization and configuration parameters for the OLES, such data being processed during initial setup. The OLES may use various encryption modes including DC-II, a proprietary system of Motorola, Inc., San Diego Calif. DC II, which generally refers to an encryption hierarchy and the collection of proprietary messages used to communicate among the controlling software, encryption and decryption devices. Further, a select packet” operating mode in which certain input MPEG packets that are not encrypted may be used. When operating in this mode, the value “00” in the transport scrambling control field (TSCF) of the MPEG packet header indicates that the packet shall not be encrypted. If the values “11” or “10” appear in a packet TSCF, then the OLES shall encrypt the packet.

Also, other modes include having the OLES support a batch operating mode in which content to be encrypted is copied into the OLES native file system, e.g., NTFS, and a real-time streaming encryption mode in which an MPEG-compliant transport stream containing one program is delivered to the OLES via the network interface. As noted, as part of the encryption process, the cryptographic keys, or the parameters used in their generation, are saved by the OLES in a data structure called an encryption record.

| Element Name | Element Value | Generating Device |
|---|---|---|
| TitleIdCode | String | OLES SW. |
| ContentTitle | String | OLES SW |
| EncryptionTime | Time | OLES SW |
| OLESId | Long | OLES Security Dev. |
| Label | Integer | OLES Security Dev. |
| EncryptionMode | Integer | OLES Security Dev. |
| EncryptedDataVersion | Integer | OLES Security Dev. |
| EncryptedDataBlock | Key Size | OLES Security Dev. |

Table I illustrates one embodiment of an encryption record according to the present invention.

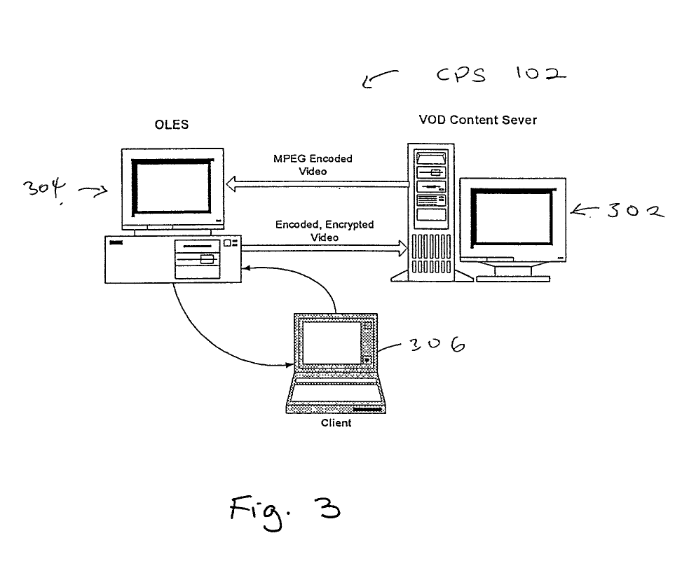

The OLES is capable of processing an MPEG content in an offline manner whereby the raw content has been completely encoded and is obtainable from a server (VOD or other server) or has been placed onto the OLES system. An exemplary embodiment of CPS 102 is further described with reference to FIG. 3. One of ordinary skill will realize that the above guidelines are exemplary and other embodiments having different guidelines are possible.

Video on Demand System (VOD System)

VOD system 108 comprises one or more video servers adapted for video on-demand applications. The servers store encrypted programs for distribution to subscribers on an on-demand basis. Thereafter, the pre-encrypted programs are routed and streamed to the authorized subscribers. In addition, VOD system 108 accepts purchase requests from subscriber terminals, and validates and authorizes such purchase requests as appropriate. In some instances, after a purchase request is approved, the VOD purchases may be temporarily stored until requested by the subscriber.

In addition to temporary storage of purchases, VOD system 108 may accept motion control requests from subscriber terminals, and accordingly perform such requests by controlling the streaming of content to the subscriber. In a first embodiment, VOD system 108 manages system resources related to video on-demand and the like such as bandwidth management, for example. VOD system 108 interfaces with other components of content system 100 to provide various functions. For example, it interfaces with VODCA 122 executing on subscriber terminals for providing user interfaces to the subscribers. Further, VOD system 108 is communicably coupled with the Billing system (BS) to report purchases, and to the Encryption Renewal System (ERS) to periodically request ECMs for pre-encrypted programs.

VOD system 108 typically resides within the cable system. Nonetheless, the exact location of the equipment constituting VOD system 108 is variable and does not affect the workings of the present invention. In a cable system built using hybrid fiber-coax (HFC) technology, VOD system 108 may be located at the head-end. Alternatively, VOD system 108 may have equipment in multiple locations, including the head end and the distribution hubs in the network. VOD system 108 may be located off-site and may serve one or more cable systems. VOD systems generally are well known in the art and need not be described in detail. Thus, VOD system 108 may comprise off-the-shelf items including hardware and software and/or customizable software in accordance with one embodiment of the present invention.

Conditional Access System (CAS)

As noted, content system 100 includes a conditional access system (CAS) 110. CAS 110 permits access to pre-encrypted content by subscriber terminals by provisioning the subscriber terminals with EMMs, and generating ECMs for non-VOD services. Other functions of CAS 110 include controlling real-time encryption devices in the cable-system; reporting the (scheduled) occurrence of periodical key changes to the encryption renewal system (described below), and transmitting cable system-specific cryptographic parameters (e.g., periodical keys) to the encryption renewal system to enable ECM retrofitting. As noted, a periodical key is typically periodical, controlling access to content by receiving units such as set-top boxes, etc. Upon expiration of the periodical key, no set-tops can decrypt content until the periodical key is renewed. CAS 110 may be located either on site or off site, and may serve multiple cable systems, in which case CAS 110 acts as multiple logical conditional access systems. Furthermore, CAS 110 interfaces with the Billing System to obtain authorization information about each subscriber, and to report purchases to the Billing System. CAS systems are well known in the art and may comprise off-the-shelf items. In addition, one of ordinary skill in the art such as a programmer can develop code as may be necessary to accommodate the present invention.

Billing System (BS)

BS 106 interfaces with both VOD system 108 and CAS 110 to provide the following functions: (1) accepting subscription and service change requests from subscribers; (2) maintaining subscriber account information; (3) billing subscribers; (4) interfacing with VOD system 108 to provide the latter with subscriber authorization status, and to collect video on-demand purchase information from the latter; and (5) providing subscriber authorization status, service and event definition information, and to collect purchase information. Although not shown, BS 106 may be several physical entities located at separate geographical locations.

Encryption Renewal System (ERS)

As shown in FIG. 1, ERS 104 interfaces with CPS 102, VOD system 108 and CAS 110. ERS 104 enables pre-encrypted content to be distributed to VOD system 108 and other authorized VOD entities while enabling access control within each CAS 110. The ERS performs ECM renewal (ECM retrofitting) in synchronization with periodical epoch rollover events occurring within each participating CAS 110. A periodical epoch is the nominal period during which a periodical key used by CAS 110 to protect the distribution of ECMs is in effect.

Encrypted content from the CPS is unusable until an initial ECM “renewal” operation is performed. To make the content useable for the first time, VODS 108 contacts ERS 104 to obtain the first set of ECMs. Henceforth, ECM renewal is performed periodically to keep valid ECMs associated with each content title on the VOD System 108. ERS 104 functions include generating encryption control parameters for initializing OLES devices; communicating with the CAS in different point-to-point systems; accepting requests from a VOD system to generate ECMs for pre-encrypted content; computing retrofitted ECMs; sending retrofitted ECMs to the requesting VOD systems, and maintaining databases of appropriate parameters. ERS 104 may also interface with VOD system 108 to forward information about (scheduled) periodical key changes to VOD system 108.

ERS 104 is implementable using hardware, software or a combination of both. For example, a number of platforms such as Sun/Solaris™ and coding language such as Java™ and operating environments such as Windows NT™, NetBSD™ may be employed in the present invention.

Distribution Network

Distribution Network 112 is a point-to-point network that distributes signals to all or a subset of the subscribers in the system. Distribution Network 112 may comprise hybrid fiber-coax (HFC) technology, for example. In an HFC network, for example, broadcast signals are distributed from the head end (central office) to a number of second level facilities (distribution hubs). Each hub in turn distributes carriers to a number of fiber nodes. In a typical arrangement, the distribution medium from the head-end down to the fiber node level is optical fibers. Subscriber homes are connected to fiber hubs via coaxial cables. At some level of distribution facility (hub, fiber node, or other distribution facilities), video on-demand carriers are broadcast to a subset of the subscriber terminal population served by the distribution facility. This typically occurs at the fiber node level. This arrangement allows the reuse of video on-demand carrier frequencies, say across fiber nodes, because different fiber nodes broadcast different video on-demand carriers to the subscribers they serve.

Interactive Network

Interactive network 114 is communicably coupled to VOD system 108 and set top population 120 to provide a two-way communication capability between the subscriber terminals and the VOD system 108. Interactive Network 114 may share some of the physical infrastructure of Distribution Network 112.

Content Preparation

Content preparation is performed at CPS 102 which has one or more (offline) encryption devices to perform the actual encryption. The offline encryption devices generate the program-specific cryptographic key(s) used to encrypt content, and are protected by physical security (physical access control or secure packaging). The encryption part of the content preparation process consists of the following steps: (1) an offline encryption device is provisioned with encryption control parameters, which are supplied by ERS 104. Such parameters may be used, for example, for the protection of encryption records by means of encryption. (2) The offline encryption devices select one or more cryptographic keys (depending on configuration) which are used to encrypt the content. (3) The offline encryption devices generate an encrypted encryption record which contains information about the keys used to encrypt the program. (4) The offline encryption device encrypts the program using the chosen key(s), and (5) the encrypted content is recorded and packaged together with the encryption record.

On Demand Delivery of Content to Subscribers

A subscriber with a set-top box 120 wishing to purchase content invokes a VODCA (VOD Client Application) 122 within a subscriber terminal of settop population 120. VODCA 122 presents a user interface to the subscriber, allowing the subscriber to select from a menu of purchasable items. The subscriber invokes a VODCA 122 function to make a purchase, after which a purchase request is forwarded to VOD system 108. The purchase request includes information about the subscriber and the item being purchased. VOD system 108 checks for availability of resources needed to fulfill the purchase, as well as the authorization status of the subscriber.

If resources are available and the subscriber is authorized according to the access control policy, the purchase request is approved. Otherwise the request is denied and the process is terminated. If the request is approved, VOD system 108 communicates the approval status of the purchase to the subscriber and allocates and assigns resources to the VOD session, including data path and carrier bandwidth. Further, VOD system 108 communicates to set-top box 120 information needed for service acquisition, e.g., a virtual channel number (an identifier that has correspondence to carrier frequency and the identification of the program within a transport multiplex). Set top box 120 performs tuning and service acquisition. VOD system 108 looks up its database to retrieve ECMs associated with the pre-encrypted program which are then streamed with the program to set-top box 120. The ECMs are the ones previously obtained form ERS 104.

Motion Control

When the subscriber invokes a motion control function, VODCA 122 sends a motion control request to VOD system 108. If the motion control request is for slow motion, scan forward, or scan backward, VOD system 108 programs the video server to change the play mode of the program. If the motion control request is for pause, the VOD system 108 bookmarks (records) the current position with the program, and controls the video server to stop the streaming. VOD system 108 starts a timer to detect the condition of an extended pause. If the timer expires, the VOD system 108 destroys the current VOD session and relinquishes the associated resources. If the motion control request is play/resume, VOD system 108 checks the status of the session. If the current session has been destroyed because of a time-out, the VOD system 108 performs a session set-up process, as in the case of an approved purchase. Otherwise, the VOD system 108 resets the (pause) timer and controls the video server to resume content streaming from the book-marked location.

ECM Retrofitting

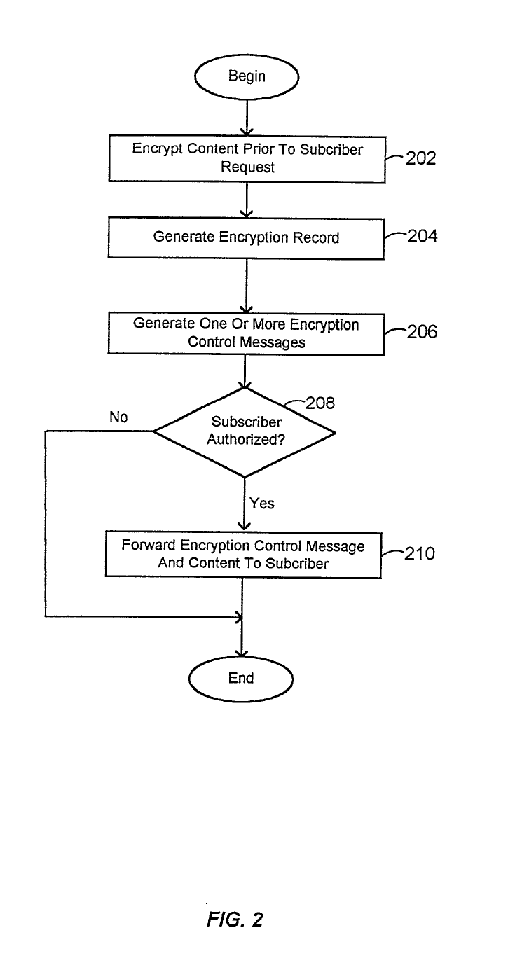

FIG. 2 is an exemplary flow diagram of the steps for ECM retrofitting in accordance with a first embodiment of the present invention.

ECM retrofitting is the process of generating and retrieving ECMs for pre-encrypted contents so that they are useable in different cable systems and despite periodical key changes. It is performed by a server hosted in ERS 104, which is a secure environment.

At block 202, content is encrypted prior to a request from a subscriber terminal. The content is pre-encrypted once at a centralized facility (and prior to distribution to various authorized head ends). ERS 104 provisions the offline encryption devices in CPS 102 with encryption control parameters which, among other functions, enable ERS 104 to retrieve information from encryption records generated by the CPS. This provisioning need be done only infrequently, or possibly just once. It need not be done with every ECM retrofitting request from the VOD system 108.

At block 204, an encryption record of parameters for encrypting the content is generated. VOD system 108 establishes a secured connection to ERS 104. To make a pre-encrypted program useable in a particular system for a particular period, VOD system 108 sends the encryption record to ERS 104.

At block 206, ERS 104 generates one or more ECMs for the pre-encrypted program using the periodical key associated with the cable system (and possibly other parameters required by the CAS). The ECM(s) are created in such a way that they will be valid until the periodical key of the target system changes again. VOD system 108 stores the retrofitted ECMs with the pre-encrypted content.

At decision block 208, VOD system 108 checks the authorization status of the requested content from VODCA 122 (FIG. 1). If the authorization check fails, VOD system 108 terminates the session. Otherwise, the process continues.

At block 210, VOD system 108 sends the retrofitted ECM(s) and pre-encrypted content to the subscriber.

Synchronizing ECM Retrofitting with Periodical key Changes

Since ECMs are cryptographically protected by a periodical key, their lifetimes are limited by the expiration of the periodical key (although their lifetimes could be limited by other factors). As the periodical key of a cable system changes, new ECMs need to be retrofitted to pre-encrypted programs. The retrofitting of ECMs therefore needs to be synchronized with the periodical key renewal process.

After a new periodical key has been generated and before the expiration of the current periodical key, CAS 110 communicates the new periodical key and its validity period to ERS 104 over a secured communication channel. This communication takes place at least t₁ minutes before the expiration of the current periodical key. VOD system 108 communicates periodically with ERS 104 to perform ECM retrofitting on newly introduced and/or existing pre-encrypted programs, to check for scheduled occurrence of periodical key changes, or both. VOD system 108 communicates with ERS 104 to perform the above function no less often than every t₁ minutes. Alternatively, ERS 104 may maintain a list of VOD systems (and the addressing information) and forward scheduled occurrences of category changes to the affected VOD system.

Access Control

Unlike broadcast services, in video on-demand only one subscriber terminal at a time is tuned to a content stream. This allows novel approaches to access control that are not applicable to broadcast services. In one embodiment of the present invention, access control is performed by both CAS 110 and VOD system 108. By using EMMs, CAS 110 limits the subscriber terminals able to process ECMs to only those authorized to do so in the cable system. This prevents pirate devices from acting like authorized ones. Depending on the functions of the CAS, authorized subscriber terminals may be further broken down into smaller groups by means of service tiering.

Since only one subscriber terminal will be receiving a content stream, VOD system 108 can deny service to an unauthorized subscriber by checking the authorization status of the subscriber and refusing to serve content to the subscriber's terminal. To prevent subscriber terminals not participating in a particular VOD session from tuning to a content stream containing a VOD program, all virtual channels allocated to VOD sessions are labeled as “hidden”. Hidden channels cannot be tuned in with the “channel up” and “channel down” controls of the subscriber terminal; they can only be tuned in by an (authorized) software application executing on the subscriber terminal. Only compliant models of subscriber terminals (i.e., ones that disallow manual tuning to hidden channels) will be allowed to subscribe to VOD. This restriction is a procedural control. Because noncompliant devices are not allowed to subscribe to VOD, they will be prevented from accessing pre-encrypted programs due to an inability to process the relevant ECMs.

The related art described in U.S. Pat. No. 5,627,892 can be adapted to provide access control in one embodiment of the present invention. To make use of the related art invention, a number of service tiers are created for the purpose of securing the VOD programs. The appropriate number of tiers depends on the number of subscribers that can receive a particular carrier containing VOD programs. For example, if pre-encrypted programs are broadcast at a fiber node level, so that 500 to 1000 subscribers are typically able to access a carrier (but not necessarily the content), 100 tiers may be an acceptable number of tiers. As will become apparent, the number of tiers affects the security of access control. Generally, a higher number of tiers provides more security.

In one embodiment, N tiers are set aside (to form a pool) in a cable system for controlling access to VOD. Each carrier containing VOD programs is broadcast to only a small segment of the subscriber population, for example at a fiber node level, as is common practice. Each subscriber terminal in the system is authorized for exactly one of the N service tiers in the pool, in a random or pseudorandom manner. The effect of such authorization assignment is that only a small number of subscribers (within a broadcast node) are enabled by the CAS to decrypt a pre-encrypted VOD program placed on a particular tier.

When VOD system 108 requests ECMs (for a particular pre-encrypted program) ERS 104 will generate N versions of ECMs, each of which specifies a different tier in the pool as an access requirement. When a subscriber purchases a pre-encrypted VOD program, VOD system 108 looks up its database and retrieves the version of ECM(s) that is associated with the purchased program and specifies the particular VOD service tier (among the N possibilities) that the subscriber's terminal has been authorized for. The ECM(s) enables the subscriber's terminal to decrypt the program. The ECM(s) are then multiplexed into the content stream which is sent to the subscriber.

FIG. 3 is a diagram of CPS 102 for encrypting content offline in accordance with an exemplary embodiment of the present invention. In FIG. 3, clear content is available from a VOD server 302 that also acts as the destination for the encrypted file. The encoded file is encrypted and verified prior to writing the encrypted material to VOD content server 302. Although not shown, client 306 may reside outside OLES 304. This configuration is not limited to having one physical device providing source material as well as the destination for the encrypted content; they can be separate file servers. The client controls the encryption session through a defined API via TCP/IP. A streaming mode of pre-encryption is also possible in which content is “streamed” from a source of raw content such as a video (possibly analog tape) through an MPEG encoder, sent to the OLES to perform encryption and finally stored on a VOD server. This system provides a “real time” sense of operation to the user. An external application may control each device in the content processing path. Given this configuration the OLES will be accessing data from the encoder prior to the completion of the encoding process. Subsequently, the OLES will provide output of encrypted content to a VOD server prior to the completion of the encoding process. The client controls the encryption session through a defined API via TCP/IP, for example.

The physical interfaces for both the streaming mode of operation and the batch-processing mode can be connected via an Ethernet network, for example. The source of the clear content (Source Content Server) and the destination device for the encrypted content may reside on a private network segment along with OLES 304. This would provide the maximum network throughput versus a network shared with corporate traffic. Registration of OLES 304 with the ERS 104 may be accomplished by human interaction, in which case no physical connection between the two is required. In such a case, the connections between the ERS 104 and OLES (CPS 102) are supported using a removable medium (e.g., floppy disk). The OLES Field Engineer retrieves certain required data from the OLES and supplies this along with other required information (gathered from sources other than the OLES software) to the ERS. The ERS generates an OLES registration file that the OLES field engineer inputs into the OLES to complete the registration process. The OLES registration file includes such information as the unique OLES ID, the available encryption types, number of encryption sessions, cryptographic information, etc., without limitation.

OLES clients may control OLES encryption sessions by means of a defined API. This API supports remote operation without the need for special client applications at the client site. It also permits clients to provide customizable software to automate encryption operations. The API may support operations to start and stop encryption sessions (including supplying all data needed to define a new session) and retrieve the status of a current encryption session. The OLES may provide a graphical user interface displayable on a web browser (like Netscape™ or Internet Explorer™) that implements the API. Access to the client functions will be protected by a security scheme (such as a username/password ACL).

The OLES hardware platform may be a commercially available microprocessor based computer, housed in a rugged chassis suitable for mounting in a standard 19″ equipment rack, 800 Mhz, 1 GB of RAM, 35 GB hard drive, and one 10/100 Base-T Ethernet card. The client commands and controls an OLES encryption session via a defined API. The OLES provides a browser-capable graphical user interface that implements the client API including various commands such as a command to stop the current encryption session.

Referring now to exemplary content guidelines, Table II below illustrates content guidelines for VOD content.

TABLE II

| Description | Notes |
|---|---|
| Clear content data is input to the OLES | |
| in the format of a binary file. | |
| A content file consists of a sequence of | |
| complete 188-byte MPEG-2 transport | |
| packets, which constitute an MPEG-2 | |
| compliant Single-Program Transport | |
| Stream (SPTS). | |
| Content files have the Program | |
| Association Table (PAT) | |
| and a Program Map Table (PMT) | |
| embedded at a nominal rate of 8 | |
| times per second | |
| For Streaming mode operation, | The PAT & PMT are required |
| content files typically begin with | for encryption. Streaming mode |
| the Program Map Table (PMT) and the | lacks the luxury of pre- |
| Program Association Table (PAT). | scanning the input to find them. |
| For the purposes of supporting selective | |
| encryption, the transport scrambling | |
| control field of the elementary stream | |
| packet headers is set to ‘00’ binary to | |
| pass the packet in the clear and set to | |
| ‘1x’ binary to cause the packet to be | |
| encrypted. | |

Encryption Rate

The content files are typically encoded at approximately three Mbps. It is desirable that a 2-hour (playback time) title be encrypted in 15 minutes. This represents a ⅛ factor of playback time to encryption time based on the encoding rate. The requirement does not take into consideration the reading of the file (i.e., from a network drive); it merely considers the time it takes to encrypt the file as if it were present on the OLES. The rate requirement stated below is a packet per second rate. This allows the statement of an encryption rate that is not dependent on the content file. The OLES is capable of performing encryption at a nominal rate of 18,000 packets per second. The OLES alternates the working key parity bit of the scrambling control field as configured for the current encryption type. It is important to note that the aforementioned guidelines are exemplary and may be modified as needed.

Selective Encryption

Selective encryption refers to the process of encrypting packet(s) (MPEG, for example) based on the transport scrambling control bits in the header. A selective encryption rate of 18,000 packets per second is attainable. The OLES provides the option of performing selective encryption based on the value of the transport scrambling control bits found in the MPEG header. The scrambling control field has the following definition for encryption: I. 00—Do not encrypt the packet; II. 1x—Encrypt the packet. One of ordinary skill will realize that the above guidelines are exemplary and other embodiments having different guidelines are possible.

Full Encryption

Full encryption refers to the process of encrypting every MPEG packet(s) regardless of the value of the transport scrambling control bits in the header. The OLES provides the option of encrypting all elementary stream packets regardless of the value of the transport scrambling control bits.

Encryption Files

In one embodiment, for each successful encryption session, the OLES generates an encrypted VOD content file and an encryption record. The encryption record is written to a formatted file such that a text editor (e.g., MS Word) can be used to view the file contents. In one embodiment, these files are transmitted to the encrypted file destination via a removable medium (e.g., floppy disk or CD ROM). The encryption record file contents may be in ASCII text and viewable using a text editor.

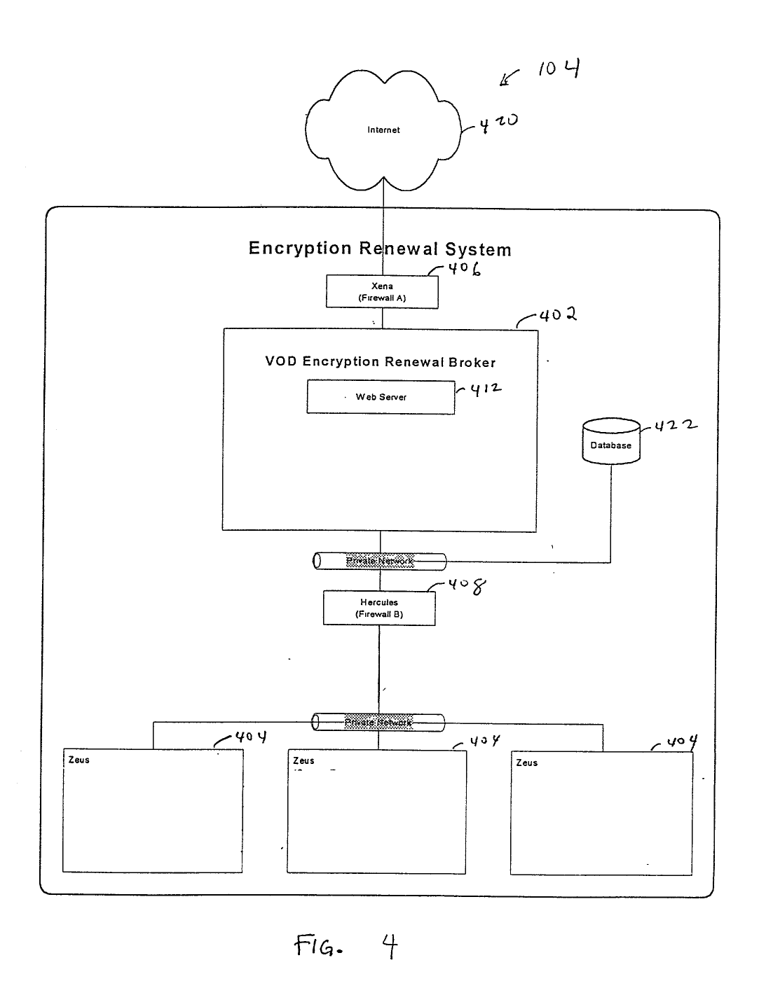

FIG. 4 is an exemplary embodiment of ERS 104 of FIG. 1. In FIG. 4, the components of ERS 104 include one or more VERBs (VOD encryption renewal) system 402 and one or more secure ECM retrofitters 404. Internet 420 traffic from VOD systems are filtered through a first firewall 406 before reaching VERB 402. The VERB parses requests (XML requests in a first embodiment), looks up and stores information in a database 422 and communicates with the ECM retrofitters Zeuses. VERB 402 to the ECM retrofitters connection is filtered by a second firewall 408. Among other components, web server 412 resides within the VERB to service the VOD system requests. Similarly, among other components, a web server 416 (not shown) resides within each ECM retrofitter to service the requests from VERB 402. Furthermore, an ASIC (application specific integrated circuit) security chip (not shown), a product of Motorola Inc., San Diego Calif. resides in each of the Zeuses to perform encryption and decryption necessary in the ECM retrofitting process. The ASIC performs the encryption and decryption within the chip to provide security against cloning.

Interface Protocol Between VERB and Zeus

In an exemplary embodiment of the present invention, the interface between VERB 402 and Zeus 404 in one embodiment is based on the Hypertext Transfer Protocol (HTTP) which is an application-level stateless object-oriented protocol. To send a request to the Zeus for example, the VERB performs an HTTP POST to a well-known URL of the Zeus. The reply from the Zeus is sent in the HTTP Response to that POST. The VERB Request/Response pairs map directly to the HTTP POST/Response pairs.

OLES Registration Request

This message is sent from the VERB to the Zeus when an OLES registers with the ERS and contains the following information, OLES ID, OLES Control Byte and other information. The string that is sent to the ZEUS as part of the POST output stream is:

msgtype=olesregistration&olesid=value&olescontrolbyte=value& olesencryptoptions=value&olesminencryptcount=value&olesmaxencryptco unt=value&olesencryptor=value&olesdecryptor=value,

where value is the actual value of the field. If there is no decryptor, then the olesdecryptor name/value pair is not present. This could happen if the OLES Control Byte is set to Single Board mode, or if it is set to Dual Board but no Decryptor is to be registered. Other messages such as OLES Registration Reply, Deliver EMM Request, ECM Retrofit Request, ECM Retrofit Reply without limitation are possible.

VOD System and Encryption Renewal System Interaction

The following section describes several interactions between the VOD system 108 and ERS 104 for various aspects of normal operation.

The Initial ECM Request

Referring to FIG. 1, the VOD system 108 receives new content (for example, a recently released movie) from the CPS 102 in the form of pre-encrypted content with an associated encryption record. However, before the content may be offered to subscribers, the VOD system may request an initial set of ECMs from ERS 104. To do this, VOD system 108 sends an ECM request (one for each content item) containing the appropriate encryption record to the ERS. In return, ERS 104 sends an ECM Response to the VOD system containing the proper ECMs, along with a callback time and the ERS synchronization number.

In one embodiment, the ECM Request and ECM Response are encapsulated in an ERSPayload, and actually allow for multiple simultaneous ECMRequests/ECMResponses. In other words, the VOD system may request ECMs for multiple content items if that is necessary. Also the ECMs generated by the ERS have a limited lifetime. Also, the very first ERSPayload to the ERS by a newly installed VOD system can include ECM Requests, if desired. However, it is desirable that the initial ERSPayload from a newly installed VOD system not include any ECMRequests, to verify proper interaction between the VOD system and ERS before ECMs are needed.

The Callback Time Mechanism and the ERS Synchronization Number

All valid ERS Transaction Responses to the VOD system 108 contain a callback time specified in Coordinated Universal Time (UTC). The format for UTC will be the following:

CCYY-MM-DDThh:mm:ssZ

“CC” represents the century, “YY” the year, “MM” the month and “DD” the day. The letter “T” is the date/time separator and “hh”, “mm”, “ss” represent hour, minute and second, respectively. The format for time is specified using Coordinated Universal Time (UTC). A “Z” immediately follows this representation to indicate Coordinated Universal Time. The callback time indicates the next time by which the VOD system should contact the ERS. If the callback time passes before the VOD system sends an ERSPayload transaction request to the ERS, then the VOD system 108 is required to send a request to the ERS.

In normal operation, new content will be added to VOD system 108 at regular intervals; thus, the VOD system sends ECM Requests to the ERS at regular intervals as well. If the VOD system sends an ECM Request to the ERS before the previous callback time was reached, then a new callback time will be received in the ERSPayload transaction response. This new callback time invalidates the previous callback time. However, if no new content is added to the VOD system and the last received callback time is reached, then the VOD system is required to contact the ERS.

Requesting the ERS Synchronization Number/ECM Lifetime and Renewal ECM Requests

All ECMs generated by the ERS for the VOD system have a limited lifetime. The duration of this lifetime is determined by CAS 110 which may terminate the lifetime of the ECMs at any time without prior notice, with a grace period. Thus, the VOD system may periodically renew the ECMs it has stored for pre-encrypted content. Since the ECM lifetime is not known in advance, the ERS provides an ERS synchronization number to the VOD system with all responses; this ERS synchronization number indicates the current lifetime period for generated ECMs. Note that all ECMs generated within a particular lifetime period share the same end of life; they all expire at the same time.

ERS Synchronization Number and ECM Lifetimes

The VOD system uses the ERS synchronization number to track ECM lifetime as follows: The VOD system records the ERS synchronization number received with each set of ECMs. Whenever any new response is received from the ERS, the ERS synchronization number contained in that response is regarded as the current ERS synchronization number. All ECMs previously stored by the VOD system that have an ERS synchronization number that does not match the current ERS synchronization number are expired and may be renewed. Note that the VOD system has a grace period during which ECMs for the old ERS synchronization number will still work properly. However, the VOD system should begin refreshing all ECMs it expects to use as soon as it knows that the current ERS synchronization number has changed. Generally, the grace period extends at least until the next callback time received in the response that provided the updated ERS synchronization number.

The VOD system may make any request to the ERS; an ERS synchronization number is always returned when the transaction completes successfully. If the VOD system requests the ERS synchronization number from the ERS because the callback time has expired, then the returned ERS synchronization number may indicate that previously requested ECMs have expired. The ERS always provides a callback time such that the VOD system is required to contact the ERS before the end of the grace period following expiration of the ECM lifetime. For example, the VOD system tracks the ERS synchronization number as follows. First, an initial ECM Request is made for new pre-encrypted content; the returned ERS synchronization number is 5. The VOD system records the ERS synchronization number with the generated ECMs and uses them whenever the pre-encrypted content is spooled out for a customer. The VOD system also records the callback time in the response and sets up a timer to expire at the callback time.

In this example, no new pre-encrypted content is added to the VOD system, so it simply counts down through time until the callback time is reached. Once the callback time is reached, the VOD system is required to contact the ERS. Since no new pre-encrypted content has been added, the VOD system simply requests the ERS synchronization number from the ERS. For this example, the ERSPayload transaction response is returned with an updated ERS synchronization number, (6); this indicates that the previous ERS synchronization number (5) has expired and all ECMs associated with that ERS synchronization number (or any other ERS synchronization number other than 6) may be renewed. The VOD system then renews the ECMs with additional ECM Requests.

By way of a further example, the VOD system tracks the ERS synchronization number as follows. Again, an initial ECM Request is made for new pre-encrypted content; the returned ERS synchronization number is 5. As before, the VOD system records the ERS synchronization number with the generated ECMs and uses the ECMs whenever the pre-encrypted content is spooled out for a customer. The VOD system also records the callback time in the response and sets up a timer to expire at the callback time. In contrast to the first example, in this example additional new pre-encrypted content is added to the VOD system. Thus, an ECM Request is made to obtain ECMs for the new pre-encrypted content. The returned ERS synchronization number is now 6, indicating that the previous ERS synchronization number (5) has expired and all ECMs with that ERS synchronization number (or any other besides 6) may be renewed. The VOD system then renews the ECMs with additional ECM Requests as with the previous example.

ECM Processing by the VOD System

Each ECM Response received by the VOD system from the ERS contains multiple ECM messages (a set of ECMs) that are to be sent with the pre-encrypted content to allow viewing by the consumer in the home. These ECMs are to be inserted into the message streams by the VOD system as indicated in the ECM Response, and conform to normal MPEG-2 message stream requirements. Specifically, each individual ECM of the set returned in the ECM Response may be inserted into the appropriate location of the ECM PID, and each message may be spaced apart in time from the previous message by at least the amount of time specified.

Before inserting the ECMs into the message stream private section, one of the data fields of the ECM may be modified. The ECMData element contains an element called “ProgramNumberOffset” which gives the location to the Program Number as an offset in bytes from the beginning of the message. This 24-bit value may be replaced with another value that is specific to the VOD system making the retrofit request. If this value is replaced, then the 32-bit CRC at the end of the message is recalculated.

VOD System/ERS Interface Specification

The following sections describe the standard lower level protocols that are used between the VOD system and the ERS. The interface between the VOD system and the ERS may be based on TCP/IP, SSL, HTTPS, and XML. XML is used to deliver data between the VOD system and ERS. As previously noted, in one embodiment of the present invention, the ERS uses XML document exchange as its fundamental protocol model. ERS protocol messages are valid XML documents, with a single ERSPayload root element and a structured hierarchy of tags describing the possible operations and data.

ERSPayload exchange is performed using HTTP as follows. To send an ERSPayload/HTTP request, the VOD system performs an HTTP POST to a well-known URL associated with the ERS. Every logical operation begins with the VOD system sending a request. ECM requests are specified using an ECMRequest XML element, and ECM responses are specified using an ECMResponse element. For ERSPayload/HTTP, the ECMRequest is sent in an HTTP POST, and the ECMResponse to that request is sent in the HTTP Response to that POST. Thus, ECM Request/Response pairs always map directly to HTTP POST/Response pairs.

The following is a pseudo-code representation of the protocol to illustrate where the use of the HTTP POST would occur. A single ERSPayload corresponds to a single HTTP POST/Response transport level transaction.

(1) VODS ERS (HTTP POST):
<ERSPayload>

<Ver1_0>

<ECMRequest> Contents of request... </ECMRequest>

</Ver1_0>

</ERSPayload>
(2) VODS ERS (HTTP Response to the POST):
<ERSPayload>

<Ver1_0>

<ECMResponse> Contents of ECM information... </ECMResponse>

</Ver1_0>

</ERSPayload>

The ERS/VODS interface protocol allows multiple requests or responses to be sent in a single payload message. This allows round-trips to be minimized whenever possible. For example, a VOD system with eight titles to be retrofitted can send all eight ECM requests and receive all eight ECM responses in a single HTTP POST/Response communication. The following is sample HTTP syntax that may be used to communicate XML transactions from the VOD system to the ERS:

POST/VODSTransaction HTTP/1.1

Host:vodsys1.vodcompany.com

Authorization:Basic dm9kczpwYXNzd28yZA=

From: admin@vodsys1.vodcompany.com

Content-Type: application/x-www-form-urlencoded

Content-Length: 30

xmldata=SomeXmlTransactionData

Reference should be made to RFC 2396 for more information on URL-encoding (required for constructing HTTP requests before sending to the ERS) and RFC 2616 for more information on HTTP/1.1.

The VOD System/ERS Interface Protocol

In an exemplary embodiment, the VOD system/ERS interface protocol is specified in XML. An XML Schema defines the grammar for XML documents exchanged between VOD systems and the ERS as protocol transactions. The VOD system and the ERS receive an entire XML document before parsing or processing any portion of the document. This ensures that errors do not occur due to processing of partial XML documents. It should be noted that the protocol has been designed to support multiple simultaneous versions. This is indicated by which <Ver XX> tag is used, (always the first child element of ERSPayload) where X.X is the protocol version currently supported and assigned to a particular VOD system to use. The XML Schema contains the current <Ver XX> tag to support the latest protocol version as well as previous <Ver XX> tags for backward compatibility. The latest protocol version is: <Ver 1.0>.

Various XML protocol transactions that flow between the ERS and VOD systems can be represented by:

Element Name: Represents the name of the field or XML element pair. For instance, if the Element Name specified were “ERSPayload”, then the corresponding XML element pair would be “<ERSPayload></ERSPayload>” (or the shorter form for the pair, “<ERSPayload/>”).

Attribute Name: Represents the name of the XML attribute that is associated with the specified element.

Direction Flow: Indicates the direction flow of transaction data from sender to receiver. The transaction data is the most meaningful for the recipient, even though the protocol may require the element or attribute to be present in either direction of transaction flow. The XML elements or attributes from the VOD system to the ERS that are required to be sent are indicated as VODSERS. Elements or attributes from the ERS to the VOD system that are required to be sent are indicated as ERSVODS. Element or attributes information required in either direction is indicated as: VODSERS.

Required: Indicates whether the current XML element or attribute is required to be present in its current context. The outermost element, ERSPayload, envelops all transactions that flow between the ERS and VOD systems. The ERSPayload element is always required (as it is the outermost element) when delivering transactions to the ERS from VOD systems and when delivering responses from the ERS to VOD systems.

Element Value: This column indicates a type and/or value (or a range of values) that are associated with Element Name or Attribute Name. In some cases there may be only a note that indicates how Element Name or Attribute Name can be used. In other cases, “None” will be the designation when there are no values associated with Element Name or Attribute Name.

Nested Elements: This applies to Element Name only when Element Name contains other nested elements. Nested elements for the protocol specification are given by the XML schema definition. The VOD system/ERS Interface Protocol supports various VOD system/ERS transaction requests/responses for protocol version 1.0. The Element Names represent the XML elements that may be used to construct a well-formed XML document. A completed XML document represents one transaction message. The Ver1_{—}0 element under the ERSPayload element sent from VOD systems to the ERS may contain up to eight ECM requests and an implicit query for the next ERS synchronization number and callback time that corresponds to the requesting VOD system. Further reference can be made to the copending U.S. Patent Application entitled “Communication Protocol for Content On Demand System with Callback Time,” filed Jul. 3, 2001, hereby incorporated by reference in its entirety.

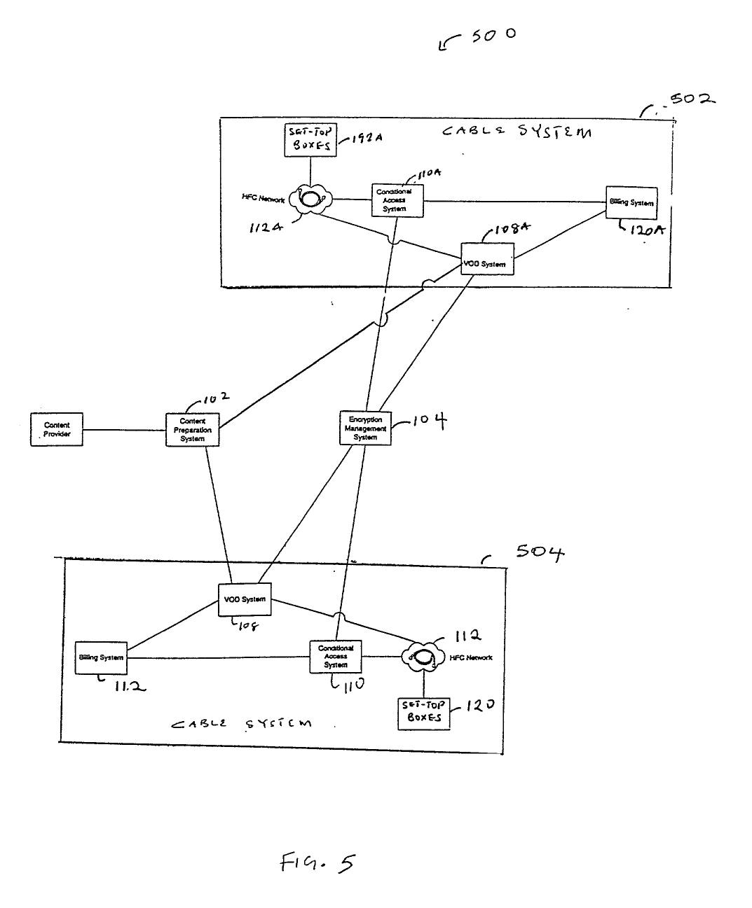

FIG. 5 is a block diagram of a network 500 for securely communicating preencrypted content in accordance with an exemplary embodiment of FIG. 1.

In FIG. 5, multiple cable systems 502, 504 are connectable to a single ERS 104, and receive content from a single CPS 102. CAS 110A and CAS 110 of cable system 502 are both coupled to ERS 104. Further, CPS 102 provides content to VOD systems 108, 108A of cable systems 504 and 502, respectively. All of the components of network 500 function in the same manner as described with reference to FIG. 1 except that components may be modified as necessary to meet requirements of network 500 and in particular, cable systems 502, 504. As noted, CASs contain information necessary to generate ECMs for authorizing VOD services, information which is required by VOD systems 108 and 108A. Connecting each CAS to each VOD system may be problematic due to the large number of CASs and VOD systems that may be paired in myriad ways and which may be placed in physically separate and geographically remote locations. One solution is to connect all CASs and VOD systems to ERS 104. ERS 104 may be a central server servicing requests from its VOD system clients, for example.

All information is coordinated at ERS 104 including generation of correct ECMs and associations between CASs and VOD systems. Networking is greatly simplified because connections between CASs and VOD systems are eliminated. An additional benefit is that the overhead of performing the authorization of VOD services, and the coordination with multiple VOD systems are removed from the CASs. CAS 110 need only communicate changes to the encryption context to the ERS 104. ERS 104 tracks and communicates with the affected VOD systems. The present embodiment de-couples CASs from the VODS and vice versa. Since no direct coupling of VOD systems and CASs exist, CAS 110 is affected only by the start/processing time of ERS 104. Likewise, the VOD system 108 is affected only by the start/processing time of the ERS, not the CAS. Since ERS 104 is not performing an ancillary function, it can be optimized to support the CASs and the VOD systems.

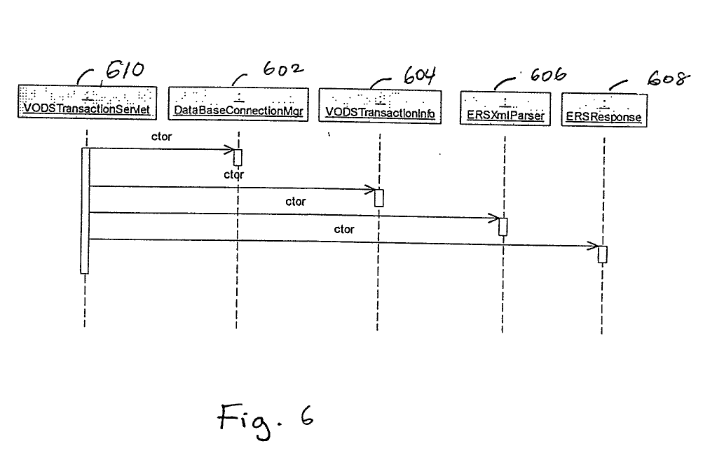

FIG. 6 is a sequence diagram of VERB 402 showing VODS transaction servlet initialization sequence of the objects involved in processing the VODS transactions. A DataBaseConnectionMgr 602 (contains a database connection), VODSTransactionInfo 604 (contains the database items pertaining to a particular VODS), ERSXmlParser 606, and the ERSResponse 608 are constructed by the VODSTransactionServlet 610. The “ctor” notation is a shorthand for “constructor”. While one example has been provided for illustrative purpose, various other interactions are possible. For example, the ERSXmlParser may create the ERSRequest (holds one transaction request from a VODS), ERSXmlErrorHandler (handles the errors found when parsing an XML document) and DOMParser (a type of an XML parser). Although not shown, software code for additions and modifications as prove necessary to accommodate the present invention can be developed by one of ordinary skill in the art such as a programmer. In this fashion, the present invention provides a system for securely delivering pre-encrypted content on-demand with access control.

While the above is a complete description of exemplary specific embodiments of the invention, additional embodiments are also possible. Thus, the above description should not be taken as limiting the scope of the invention, which is defined by the appended claims along with their full scope of equivalents. For example, while the specification references point-to-point communication systems such as cable systems, one of ordinary skill in the art will realize that the present invention is applicable to multi-point and multicast systems.

What is claimed is:

1. A system for delivering content to a subscriber terminal on-demand through a communication network, the system comprising:
a content preparation module for preencrypting the content offline to form pre-encrypted content;
an on-demand module receiving the pre-encrypted content from the content preparation module, for storing, and transmitting the pre-encrypted content to the subscriber terminal when authorized;
an encryption renewal system interfacing with the on-demand module to generate entitlement control messages allowing the pre-encrypted content to be decryptable for a designated duration; and
a conditional access system for providing a periodical key to the encryption renewal system, to permit generation of the entitlement control messages that convey information required to decrypt the pre-encrypted content including the periodical key to the subscriber terminal.

2. The system of claim 1 wherein the communication network is a cable network for distributing audio/video content from a cable central office to all or a subset of subscriber terminals.

3. A method of delivering content from one or more cable systems to subscriber terminals within the cable systems, the cable systems being communicatively coupled to an offline encryption device, the method comprising:
receiving by a first cable system, a request for the content from a first subscriber terminal of the first cable system;
preencrypting, by the offline encryption device, the content to form pre-encrypted content prior to the step of receiving a request;
generating an encryption record containing parameters employed for encrypting the content;
based on the encryption record and a first key information, generating one or more control messages for permitting access to the pre-encrypted content; and
transmitting the pre-encrypted content associated with the one or more control messages to the first subscriber terminal for decryption of the pre-encrypted content.

4. The method of claim 3 further comprising
receiving, by a second cable system, a request from a second subscriber terminal of the second cable system, and
based on the encryption record and a second key information, generating one or more control messages for permitting the second subscriber terminal to access the pre-encrypted content.

5. The method of claim 3 wherein the first key information is provided by a conditional access system that uses the key information to control the first subscriber terminal.

6. The method of claim 5 wherein the key information is for a key that is periodical and valid for a designated duration.

7. The method of claim 6 wherein the designated duration is shortly before, contemporaneous with, or shortly after the first key is changed by the conditional access system.

8. The method of claim 3 wherein the one or more control messages is a first entitlement control message for conveying information to the first subscriber terminal to compute a key.

9. The method of claim 3 further comprising
changing the first key information after a designated duration, and reporting the key change by the first cable system.

10. The method of claim 3 further comprising
retrofitting a second entitlement control message to the pre-encrypted content for permitting access to the pre-encrypted content after the first key information expires.

11. The method of claim 10 wherein the retrofitting of the second control message employs a second key information.

12. The method of claim 11 wherein the step of retrofitting the second entitlement control message is synchronized with changing of a first key information to the second key information.

13. The method of claim 3 further comprising
providing the parameters from an encryption renewal system that generates the one or more entitlement control messages.

14. The method of claim 13 wherein the step of generating an encryption record is by an offline encryption system.

15. The method of claim 4 further comprising
providing first and second service tiers in the first cable system to further limit access to the pre-encrypted content.

16. The method of claim 15 further comprising
generating a first entitlement control message allowing the first subscriber terminal to access the pre-encrypted content only in the first service tier, and
generating a second entitlement message allowing a second subscriber terminal to access the pre-encrypted only in the second service tier.

17. A system for delivering first and second content to a subscriber terminal on-demand through a communication network, the system comprising:
means for pre-encrypting the first and second content offline to form first and second pre-encrypted content, and for generating a first encryption record associated with the first pre-encrypted content, and a second encryption record for the second pre-encrypted content;
means for generating a first and second entitlement messages that allow decryption of the first and second pre-encrypted contents, respectively;
a conditional access system for providing information included in the first and second entitlement messages by the means for generating; and
means for receiving the pre-encrypted content from the means for pre-encrypting, forwarding the first and second encryption records to the means for generating which generates the first and second entitlement messages for forwarding to the subscriber terminal.

18. The system of claim 17 further comprising means for generating a third entitlement message.

19. The system of claim 18 wherein the third entitlement message is for permitting access to the first pre-encrypted content after expiration of the first entitlement message.

20. A method using an encryption renewal system, the method permitting first and second communication systems to control subscriber access to pre-encrypted content that was previously encrypted offline, the method comprising:
receiving, by the encryption renewal system, a first cryptographic information from the first communication system;
receiving an encryption record containing parameters employed during encryption to form the pre-encrypted content; and
generating for the first communication system, a first control message for providing access to the pre-encrypted content based on the first cryptographic information and the first encryption record.

21. The method of claim 20 further comprising
receiving, by the encryption renewal system, a second cryptographic information from the second communication system;
receiving the encryption record containing parameters employed during encryption to form the pre-encrypted content; and
generating for the second communication system, a second control message for providing access to the pre-encrypted content based on the second cryptographic information and the encryption record.

22. The method of claim 20 further comprising generating a third control message upon expiration of the first control message, to provide access to the pre-encrypted content.

23. The method of claim 20 further comprising
retrieving entitlement control messages associated with the pre-encrypted content; and
specifying a tier to which a subscriber is authorized when the pre-encrypted program is purchased.

24. A system for delivering content to a subscriber terminal on-demand through a point-to-point communication network, the system comprising:
an offline encryption system having software containing one or more instructions for pre-encrypting the content to form pre-encrypted content before a content request is received from the subscriber terminal;
a video on-demand system including software having one or more instructions for receiving the pre-encrypted content from the offline encryption system, and forwarding the pre-encrypted content to the subscriber terminal; and
an encryption renewal system interfacing with the offline encryption system to provide encryption parameters for encrypting the content, and interfacing with the video on-demand system to generate entitlement control messages allowing the pre-encrypted content to be decryptable for a designated duration, wherein the entitlement control messages are generated by using a periodical key.

25. The system of claim 24 further comprising a conditional access system having software interfacing with a billing system to coordinate subscriber access to the pre-encrypted content based on a subscriber purchase.

26. The system of claim 24 further comprising an interactive system including software having instructions for providing two-way subscriber interaction between the subscriber system and the video on-demand system.

27. The system of claim 24 further comprising one or more service tiers to secure the pre-encrypted content.

28. The system of claim 24 wherein the encryption renewal system generates first and second versions of an entitlement control message, for accessing the pre-encrypted content in a first and a second tier, respectively.

29. The system of claim 24 further comprising
retrieving entitlement control messages associated with the pre-encrypted content, and specifying the tier for which a subscriber is authorized when the pre-encrypted program is purchased.

30. The system of claim 24 wherein the encryption renewal system provides a call back mechanism indicating the next time by which the video on-demand system should contact the encryption renewal system.

31. The method of claim 20 further comprising providing a call back mechanism.

32. The method of claim 20 further comprising maintaining a list of first, second and third communication systems and their addressing information.

33. The method of claim 3 wherein the step of pre-encrypting is carried out using a third key, and the encryption record contains information about the third key.

34. The method of claim 33 further comprising translating the third key into the first key information.

35. The system of claim 25 wherein the video on-demand system and the conditional access system are decoupled.

36. The system of claim 25 wherein the video on-demand system and the conditional access systems comprise a first cable system, each communicably coupled to the encryption renewal system.

37. The system of claim 36 further comprising a second cable system having a second conditional access system and a second video on-demand system each communicably coupled to the encryption renewal system.

38. A method of delivering pre-encrypted content to subscribers from a first and a second communication system the method comprising:
preencrypting the content once at a centralized facility, and prior to distribution to the first and second communication systems;
if the first communication is authorized to receive the content, transmitting the content to the first communication system;
storing the content by the first communication system;
if the second communication system is authorized to receive the content, transmitting the conent to the second communication system; and
storing the content by the second communication system, wherein the content is distributable by the first communication system to a first subscriber within the first communication system upon request from the first subscriber, and the content is distributable by the second communication system to a second subscriber within the second communication system upon request.

39. The method of claim 38 wherein the pre-encrypted content is encrypted prior to transmitting the content to the first and second communication system.

40. The method of claim 20 further comprising assigning subscriber tiers, so that only a designated number of subscribers share each subscriber tier within a fiber node.
